(19) United States
(12) Patent Application Publication
(10) Pub. No.: US 2017/0078458 A1
(43) Pub. Date: Mar. 16, 2017

(54) CLASSIFIER, COMMUNICATION DEVICE, AND COMMUNICATION METHOD

(71) Applicant: KABUSHIKI KAISHA TOSHIBA, Tokyo (JP)

(72) Inventors: Takeshi ISHIHARA, Yokohama (JP); Kensaku YAMAGUCHI, Kawasaki (JP); Yuta KOBAYASHI, Kawasaki (JP); Takahiro YAMAURA, Kawasaki (JP)

(21) Appl. No.: 15/259,341

(22) Filed: Sep. 8, 2016

(30) Foreign Application Priority Data
Sep. 14, 2015 (JP) 2015-181096

(51) Int. Cl. H04L 29/06

(52) U.S. Cl. CPC H04L 69/22; H04L 69/161; H04L 69/12

(57) ABSTRACT

According to one embodiment, there is provided a classifier arranged in a communication device including at least one protocol processor that performs a predetermined processing on a received packet. The classifier includes processing circuitry being configured to specify the protocol processing to be performed on the packet on the basis of classification information of the packet; and notify the packet and additional information used for performing the specified protocol processing to the protocol processor which performs the specified protocol processing.

### CROSS-REFERENCE TO RELATED APPLICATIONS

This application is based upon and claims the benefit of priority from Japanese Patent Application No. 2015-181096, filed Sep. 14, 2015; the entire contents of which are incorporated herein by reference.

### FIELD

Embodiments described herein relate to a classifier, a communication device, and a communication method.

### BACKGROUND

There has been conventionally known a technique which makes a classifier classifies packets received from a network and causes a predetermined core or thread in a multicore processor depending on the classification result to perform the relevant processing. As a packet classification method using a classifier, there have been proposed a method using values in fields obtained through scanning of a header of a packet and a method using hash values generated from the values in fields.

According to the above conventional technique, packet classification processing can be accelerated and processes can be concentrated on a particular core so that efficient packet processing can be performed. However, conventional classifiers specialize in classification processing, and cooperation with post-stage processes is not considered. Therefore, even when a header of a packet has been scanned by a classifier, the header needs to be scanned again in a post stage in the processing. Such overhead in processing causes reduction in processing efficiency.

### BRIEF DESCRIPTION OF THE DRAWINGS

FIG. 1 is a diagram illustrating an example of a hardware configuration of a communication device according to a first embodiment;

FIG. 2 is a diagram illustrating a logical connection relationship in the communication device in FIG. 1;

FIG. 3 is a flowchart showing operations of the communication device in FIG. 1 when the device receives a packet;

FIG. 4 is a diagram showing an example of entries in the first embodiment;

FIG. 5 is a diagram illustrating a logical connection relationship in a communication device according to a second embodiment;

FIG. 6 is a diagram illustrating an example of a packet received by the communication device;

FIG. 7 is a diagram showing an example of entries in the second embodiment;

FIG. 8 is a diagram showing another example of entries in the second embodiment;

FIG. 9 is a diagram showing a modification of the entries in FIG. 8;

FIG. 10 is a diagram showing another modification of the entries in FIG. 8;

FIG. 11 is a diagram illustrating an example of a first notification method in the second embodiment;

FIG. 12 is a diagram illustrating another example of the first notification method in the second embodiment;

FIG. 13 is a diagram illustrating an example of a second notification method in the second embodiment;

FIG. 14 is a flowchart showing operations of the communication device in FIG. 5 when the device receives a packet;

FIG. 15 is a flowchart showing an example of protocol processing performed by a plurality of protocol processors;

FIG. 16 is a flowchart showing another example of protocol processing performed by a plurality of protocol processors;

FIG. 17 is a flowchart showing an example of a plurality of protocol processes performed by a processor;

FIG. 18 is a diagram illustrating a logical connection relationship in a communication device according to a third embodiment;

FIG. 19 is a diagram showing an example of entries in the third embodiment; and

FIG. 20 is a diagram showing another example of the entries in the third embodiment.

### DETAILED DESCRIPTION

According to one embodiment, there is provided a classifier arranged in a communication device including at least one protocol processor that performs a predetermined processing on a received packet. The classifier includes processing circuitry being configured to specify the protocol processing to be performed on the packet on the basis of classification information of the packet; and notify the packet and additional information used for performing the specified protocol processing to the protocol processor which performs the specified protocol processing. Hereinafter, embodiments of the present invention will be described with reference to the drawings.

### First Embodiment

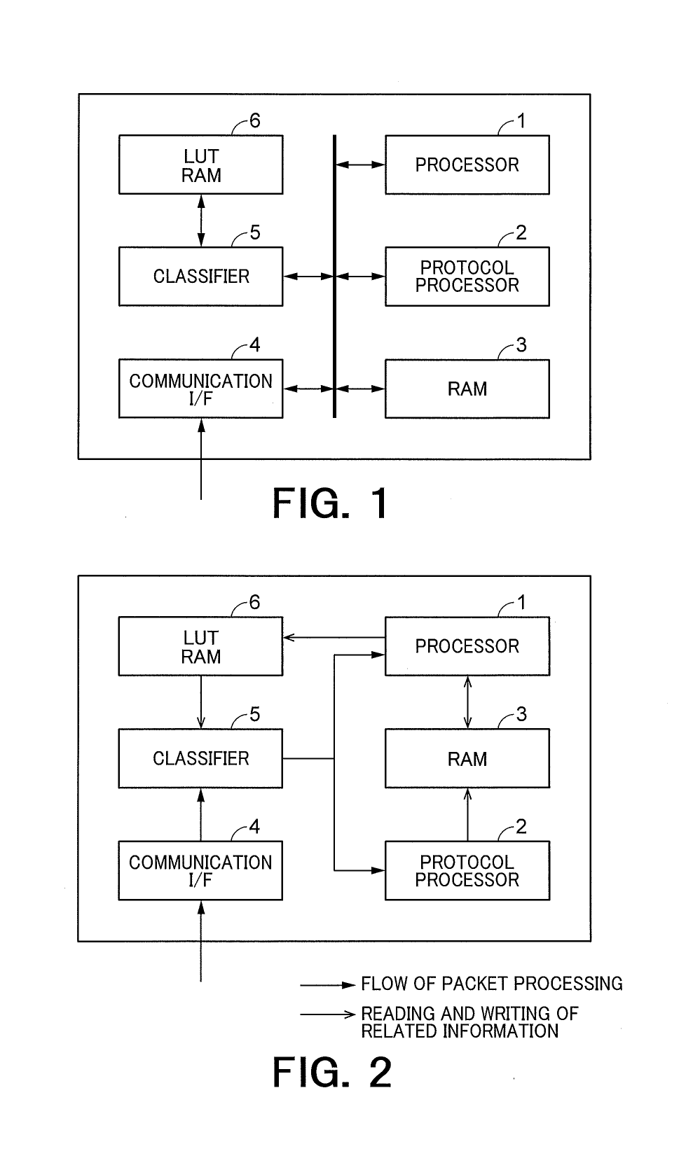

A communication device according to a first embodiment will be described with reference to FIGS. 1 to 4. FIG. 1 is a diagram illustrating an example of a hardware configuration of the communication device according to the present embodiment. As illustrated in FIG. 1, the communication device includes a processor 1, a protocol processor 2, a RAM 3, a communication I/F 4, a classifier 5, and a LUT RAM 6.

The processor 1, which is hardware processor, executes various programs on the RAM 3, controls the entire communication device, and processes a packet received by the communication device. Packet processing to be performed by the processor 1 includes protocol processing to be performed by the protocol processor 2.

The protocol processor 2 performs, on a packet received by the communication device, predetermined protocol processing such as TCP, IP, and UDP. The protocol processor 2 may be a dedicated processor optimized for protocol processing or may be a processor which is designed to execute a program for performing predetermined protocol processing and which is similar to the processor 1. The protocol processor 2 is a TCP offload engine (TOE), for example, but the protocol processor 2 is not limited thereto.

The RAM 3 stores therein programs to be executed by the processor 1 or the protocol processor 2, or packets received by the communication device. The RAM 3 is used by the processor 1 and the protocol processor 2. For example, a SRAM, a DRAM, a ReRAM, a PCRAM, or a MRAM can be used as the RAM 3.

The communication I/F (interface) 4 connects the communication device and a network to each other. The communication I/F 4 receives a packet from the network, and stores the received packet in the RAM 3. Further, the communication I/F 4 notifies the received packet to the classifier 5.

The classifier 5 classifies packets received by the communication device in accordance with classification information such as processing details to be performed on the packet, a processor (the processor 1 or the protocol processor 2) to perform processing on the packet, and a processing priority. The classifier 5 is configured by processing circuitry such as a dedicated circuit, a hardware processor, a CPU as one example. The term “circuitry” may refer to not only electric circuits or a system of circuits used in a device but also a single electric circuit or a part of the single electric circuit.

More specifically, the classifier 5 determines whether a packet is processable by the protocol processor 2. The classifier 5 notifies to the protocol processor 2 a packet determined to be processable by the protocol processor 2 together with additional information. The packet notified to the protocol processor 2 is subject to protocol processing performed by the protocol processor 2. Further, the classifier 5 notifies to the processor 1 a packet determined to be not processable by the protocol processor 2. The packet notified to the processor 1 is subject to packet processing performed by the processor 1. Additional information and classification information will be described in detail later.

The LUT RAM 6 is a storage to store therein a lookup table (hereinafter, referred to as “LUT”) having entries to be used by the classifier 5 stored therein. Each entry includes classification information, and additional information according to the classification information or an identifier thereof. The entries are created by the processor 1. The classifier 5 classifies packets with reference to a LUT on the LUT RAM 6.

The LUT RAM 6 is preferably configured to allow the classifier 5 to refer to the LUT RAM 6 at a high speed. For example, an SRAM, a DRAM, a ReRAM, a PC RAM, an MRAM, or a content addressable memory (CAM) using them as memory elements can be used as the LUT RAM 6.

The communication device may further include an auxiliary storage such as an HDD and an SSD, which are not illustrated in FIG. 1.

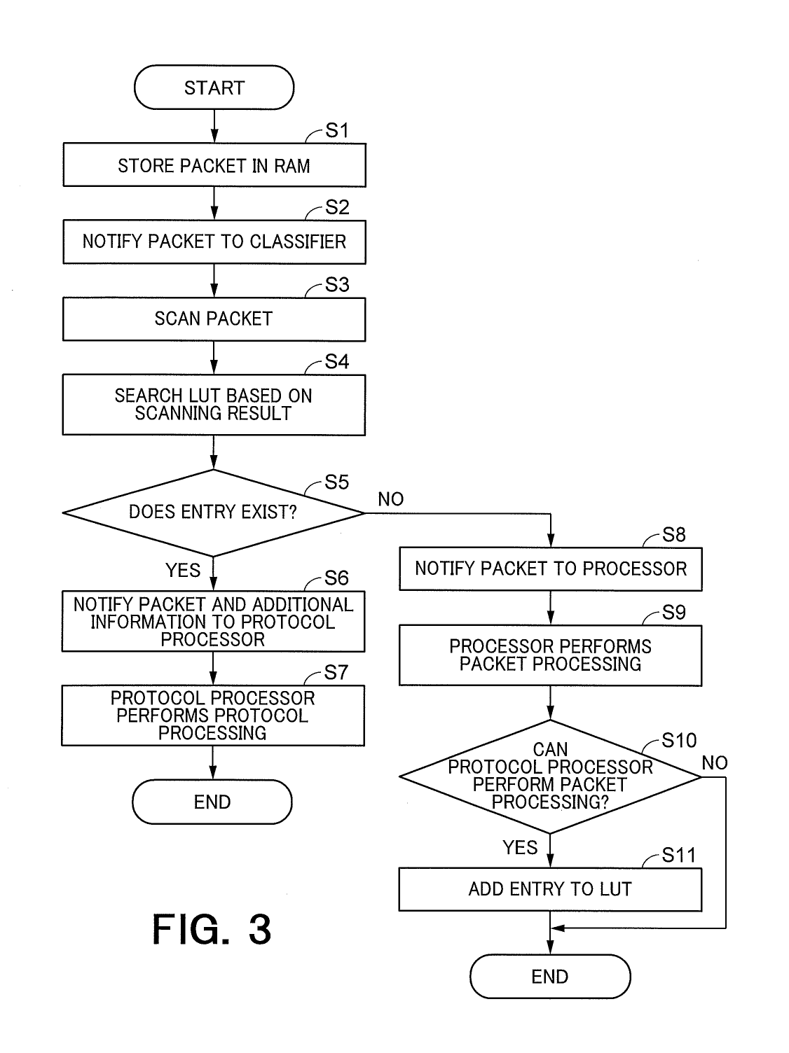

Operations of the communication device according to the present embodiment will be described with reference to FIGS. 2 and 3. FIG. 2 is a diagram illustrating a logical connection relationship in the communication device in FIG. 1. FIG. 3 is a flowchart showing operations of the communication device in FIG. 1 when the device receives a packet.

As shown in FIG. 3, when the communication I/F 4 receives a packet via a network, the communication I/F 4 stores the received packet in the RAM 3 (Step S1). The packet is stored in the RAM 3 by a method such as DMA.

Next, the communication I/F 4 notifies the received packet to the classifier 5 (Step S2). Notification of the packet may be done by delivering a part or the whole of the received packet to the classifier 5, or may be done by notifying to the classifier 5 an identifier (an address, a pointer, or the like) of the packet stored in the RAM 3. When the identifier of the packet is notified, the amount of information notified from the communication I/F 4 to the classifier 5 can be reduced compared with a case where the packet is delivered.

The classifier 5 having received the notification of the packet from the communication I/F 4 first scans the notified packet (Step S3), and acquires the classification information of the packet.

Here, classification information will be described. Classification information refers to information for specifying protocol processing to be performed on a packet. On packets having the same classification information, the same processing is performed by the communication device.

For example, information (a transmitter IP address, a destination IP address, the type of a protocol, a transmitter port number, and a destination port number, etc.) included in the IP header or the TCP header of the packet is used as classification information.

As classification information, information other than information included in an IP header or a TCP header can be used. For example, classification information may be information included in another header region (a TOS field, a flow label field, a flag, etc.), may be the whole or a part of application data (which may be specified by a length from the head, for example) stored rearward of the TCP header, may be information included in a particular field (an HTTP URL, User-Agent, etc.) obtained through interpretation of an application protocol, may be a VLAN tag or any label provided to a packet or a frame, may be an identifier for specifying a MAC address, a protocol field, and a VPN connection, or may be combination thereof. Further, classification information may be a hash value calculated from the above information.

The classifier 5 searches the LUT on the basis of the classification information obtained through scanning of the packet (Step S4). That is, the classifier 5 searches for an entry corresponding to the packet. An entry corresponding to the packet refers to an entry including classification information that matches the classification information of the packet.

When the classifier 5 finds out an entry corresponding to the packet as a result of searching of the LUT (Yes at Step S5), the classifier 5 determines that the packet is processable by the protocol processor 2 and notifies the packet and additional information to the protocol processor 2 (Step S6).

Here, additional information will be described. Additional information refers to information required for the protocol processor 2 to perform protocol processing on a packet. For example, additional information is information included in a TCB (TCP Control Block) and a PCB (Protocol Control Block), but is not limited thereto. For example, a TCB includes information such as the state of a TCP, a sequence number, an ACK number, a maximum segment size, a congestion window size, a flag, and a pointer to a transmission buffer. For example, a PCB includes information such as the number of pieces of transmitted data, the number of transmitted packets, the number of pieces of received data, the number of received packets, the number of transmission error packets, and the number of reception error packets.

The additional information notified by the classifier 5 may have a data structure similar to that of a TCB or a PCB, or may have a different data structure.

Notification of the additional information may be done by delivering the additional information itself to the protocol processor 2. In this case, each entry on the LUT RAM 6 includes additional information corresponding to the classification information of the entry. The classifier 5 may notify the additional information by delivering additional information included in an entry to the protocol processor 2.

Alternatively, notification of the additional information may be done by notifying to the protocol processor 2 an identifier (an address, a pointer, or the like) of additional information stored in the RAM 3. In this case, each entry on the LUT RAM 6 includes the identifier of additional information corresponding to the classification information in the entry. The classifier 5 may notify the additional information to the protocol processor 2 by notifying additional information included in an entry to the protocol processor 2.

The additional information is not necessarily required to be specified directly from entries on the LUT RAM 6. For example, an additional information table including hash values corresponding to all or some fields in each entry on the LUT RAM 6 and additional information associated with the hash values is stored in the LUT RAM 6 or the RAM 3. Then, the classifier 5 may search the stored additional information table, specify additional information corresponding to the packet, and notify the specified additional information.

When the additional information includes a plurality of pieces of information, the classifier 5 may notify the identifiers of the pieces to the protocol processor 2. When the identifiers of the additional information are notified, an amount of information notified from the classifier 5 to the protocol processor 2 can be reduced compared to the case where the additional information itself is delivered.

More specifically, the classifier 5 can notify a packet and additional information using a descriptor. In this case, the classifier 5 may create a descriptor having a packet or an identifier thereof and additional information or an identifier thereof stored therein, and notify the created descriptor to the protocol processor 2.

Further, the classifier 5 can notify additional information using a processed region in a packet. For example, when the protocol processor 2 performs TCP/IP protocol processing, the MAC header of a packet notified to the protocol processor 2 is considered to have been processed. In this case, the classifier 5 may store additional information or an identifier thereof in the MAC header (for example, a region of a transmitter MAC address or a destination MAC address, etc.) of the packet, and deliver the packet to the protocol processor 2.

Further, the classifier 5 can notify additional information using an unused region of a buffer storing the packet therein. For example, when a buffer storing therein the packet has a fixed length, an unused region may exist at the top or end of the buffer. The classifier 5 may store additional information or an identifier thereof in the unused region and deliver the buffer to the protocol processor 2.

Still further, the classifier 5 can give a notification using a register of the protocol processor 2. In this case, the classifier 5 may write the packet or an identifier thereof and additional information or an identifier thereof directly in the register of the protocol processor 2. Since the capacity of the register is generally small, the classifier 5 preferably writes only the identifiers of the packet and additional information.

The classifier 5 may notify the packet and additional information to the protocol processor 2 by an identical method, or by different methods. A notification method of the packet and additional information can be selected arbitrarily from among the above methods.

The protocol processor 2 having received the notification of the packet and additional information from the classifier 5 performs protocol processing on the notified packet using the notified additional information (Step S7). When the classifier 5 has delivered the additional information itself to the protocol processor 2, the protocol processor 2 may use the additional information. When the classifier 5 has notified the identifier of additional information to the protocol processor 2, the protocol processor 2 may read out a region on the RAM 3 specified by the identifier and acquire additional information. Variety types of data obtained during protocol processing are stored in the RAM 3. After the protocol processor 2 has performed protocol processing, the processing to be performed by the communication device ends.

On the other hand, when the classifier 5 fails to find out an entry corresponding to the packet as a result of searching of the LUT (No at Step S5), the classifier 5 determines that the packet cannot be processed by the protocol processor 2 and notifies the packet to the processor 1 (Step S8).

The processor 1 having received the notification of the packet from the classifier 5 executes a program according to the notified packet to perform packet processing (Step S9).

Here, packet processing performed by the processor 1 will be described using an example of a case where the processor 1 performs TCP/IP protocol processing. In TCP/IP protocol processing performed by the processor 1, the processor 1 scans the IP header of the packet and determines whether the destination IP address of the packet matches the IP address assigned to its own node or whether the IP checksum is appropriate.

When the notified packet is not addressed to its own node or when the IP checksum is not appropriate, the processor 1 ends the protocol processing (not shown).

When the notified packet is addressed to its own node and the IP checksum is appropriate, the processor 1 performs processing of an upper layer next to the IP header. Here, the TCP header is assumed to be added as the header of the upper layer.

In this case, the processor 1 scans the TCP header, and specifies a transmitter port number or a destination port number, determines whether the TCP checksum is appropriate, and the like. When the TCP checksum of the notified packet is not appropriate, the processor 1 ends the protocol processing (not shown).

When the TCP checksum is appropriate, the processor 1 scans the RAM 3 and searches for additional information (e.g., TCP management information) which matches the specified transmitter port number or the specified destination port number.

When the processor 1 finds out additional information which matches the specified transmitter port number or the specified destination port number, the processor 1 continues the protocol processing using the found additional information, and notifies the protocol-processed packet (application data) to an application using TCP/IP.

When the protocol processor 1 fails to find out additional information which matches the specified transmitter port number or the specified destination port number, the processor 1 determines that the received packet corresponds to a new communication, creates additional information corresponding to the received packet, and stores the created additional information in the RAM 3.

Next, the processor 1 determines whether the packet processing having been performed at Step S9 can be performed by the protocol processor 2 (Step S10). For example, the processor 1 may determine whether the packet processing can be performed by the protocol processor 2 on the basis of whether a particular process or a particular function has been executed in a program. In this case, information indicating whether the packet processing can be performed by the protocol processor 2 may be given in advance to the particular process or the particular function in the program.

Alternatively, the processor 1 may perform processing of determining whether the protocol processing can be performed by the protocol processor 2 from information such as the port number specified from the received packet or created additional information. As such processing, the protocol processor 2 may perform processing of determining whether the received packet has a particular destination port number, or may perform processing of confirming that an option field not supported by the protocol processor 2 is not included, for example.

When it is determined that the protocol processor 2 cannot perform the packet processing (No at Step S10), the processing to be performed by the communication device ends.

When it is determined that the protocol processor 2 can perform the packet processing (Yes at Step S10), the processor 1 creates a new entry on the basis of the additional information and the classification information of the packet stored in the RAM 3, and adds the created entry to the LUT stored in the LUT RAM 6 (Step S11).

The processor 1 may create an entry so as to associate classification information and additional information with each other. However, the processor 1 preferably creates an entry so as to associate classification information and the identifier of the additional information with each other. Accordingly, an amount of information stored in the LUT can be reduced compared to a case where an entry is created so as to associate classification information and additional information with each other.

A format of additional information or classification information stored in the RAM 3 and that of additional information or classification information stored in an entry may be identical with each other, or may differ from each other. Further, the processor 1 may or may not store a new created entry in the RAM 3. Moreover, when storing an entry in the RAM 3, the processor 1 may omit storing classification information.

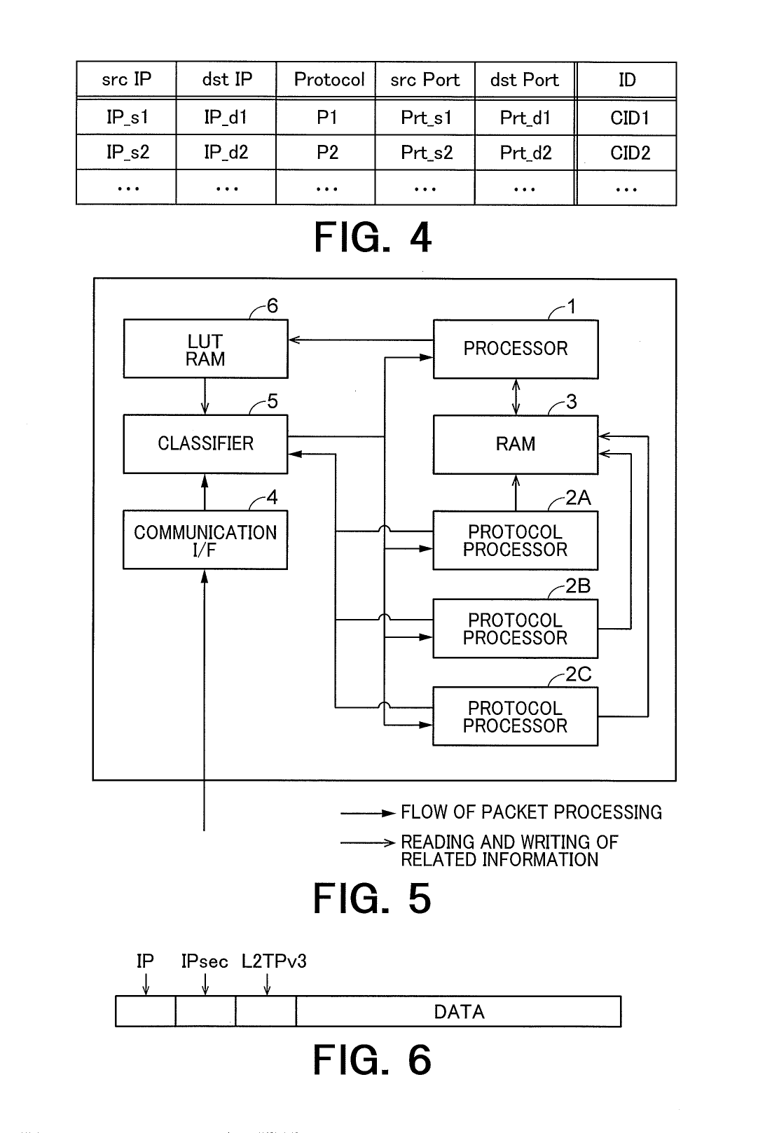

FIG. 4 is a diagram showing an example of entries stored in the LUT. In the example in FIG. 4, in each entry, classification information and the identifier (ID) of additional information are associated with each other. The classification information in each entry in FIG. 4 includes a transmitter IP address (src IP), a destination IP address (dst IP), a protocol type (Protocol), a transmitter port number (src Port), and a destination port number (dst Port).

Using an example where the communication I/F 4 receives a packet X corresponding to the entry in the first line in FIG. 4, operations of the communication device will be specifically described.

When the communication I/F 4 receives the packet X, the communication I/F 4 stores the packet X in the RAM 3 (Step S1) and notifies the identifier of the packet X to the classifier 5 (Step S2). The classifier 5 scans the packet X stored in the RAM 3 on the basis of the notified identifier (Step S3), acquires the classification information (IP_s1, IP_d1, P1, Prt_s1, Prt_d1) of the packet X, and searches the LUT on the basis of the acquired classification information of the packet X (Step S4).

When the entry in the first line in FIG. 4 is stored in the LUT, the entry is found out as an entry corresponding to the packet X (Yes at Step S5). Accordingly, the classifier 5 notifies to the protocol processor 2 the identifier of the packet X and the identifier (CID1) of additional information included in the entry in the first line in FIG. 4 (Step S6).

The protocol processor 2 acquires additional information specified by the notified identifier (CID1) from the RAM 3, and performs protocol processing on the packet X using the acquired additional information (Step S7).

When the entry in the first line in FIG. 4 is not stored in the LUT, no entry corresponding to the packet X is found out (No at Step S5). Accordingly, the classifier 5 notifies the identifier of the packet X to the processor 1 (Step S8). The processor 1 performs predetermined packet processing on the notified packet X (Step S9). The additional information of the packet X acquired through packet processing performed by the processor 1 is stored in the RAM 3.

When the packet processing performed by the processor 1 cannot be performed by the protocol processor 2 (No at Step S10), the processing to be performed by the communication device ends.

When the packet processing performed by the processor 1 can be performed by the protocol processor 2 (Yes at Step S10), the processor 1 creates an entry in which the identifier (CID1) of the additional information stored in the RAM 3 and the classification information (IP_s1, IP_d1, P1, Prt_d1) of the packet X are associated with each other, and stores the created entry in the LUT. The stored entry corresponds to the entry in the first line in FIG. 4.

Thereafter, a packet having classification information same as that of the packet X is notified from the classifier 5 to the protocol processor 2, and the protocol processor 2 performs protocol processing on the packet.

As described above, in the communication device according to the present embodiment, the protocol processor 2 receives from the classifier 5 a notification of additional information required for protocol processing. For this reason, the protocol processor 2 can perform protocol processing without scanning a packet in order to acquire additional information. Accordingly, according to the present embodiment, overhead in processing due to scanning of packets performed by each of the classifier 5 and the protocol processor 2 can be reduced. Therefore, a time required for the protocol processor 2 to perform protocol processing can be reduced.

In addition, according to the present embodiment, on a packet that cannot be protocol processed by the protocol processor 2, the processor 1 performs packet processing. That is, the protocol processor 2 does not need to perform exceptional processing for a case where a packet that cannot be protocol processed is input. Therefore, exceptional processing can be omitted from protocol processing to be performed by the protocol processor 2.

When the protocol processor 2 is configured by a dedicated circuit such as a TOE, reduction in protocol processing allows reduction in circuit size of the protocol processor 2. As a result, reduction in size of the communication device and low power consumption can be achieved.

In the present embodiment, entries stored in the LUT are deleted after completion of a set of communications. Examples of the completion of communications include normal completion and abnormal completion. For example, normal completion corresponds to a case where a packet in which a FIN flag of TCP is set is replaced. For example, abnormal completion corresponds to a case where a packet in which a RST flag of TCP is set is notified. Completion of communications may be detected by the processor 1 or the protocol processor 2.

When communications are performed using a protocol other than TCP and communication completion is explicitly performed (for example, when the length of a packet to be replaced before communication completion is notified to the communication device in advance), entries may be deleted after communication completion is detected as in the above case.

In a case where communication completion is not explicitly performed (for example, a case where stateless communications are performed using UDP), when a packet to be processed by the protocol processor 2 is not received for a predetermined time or more, entries may be deleted by considering that the communications has been completed.

In addition, when there is an upper limit to the number of entries that can be stored in the LUT, entries stored in the LUT may be deleted at every predetermined time or may be replaced so as to prevent the number of entries from reaching the upper limit. For example, entries stored in the LUT may be replaced using a general replacement algorithm such as LRU (Least Recently Used), LFU (Least Frequently Used), and FIFO (First In First Out).

### Second Embodiment

A communication device according to a second embodiment will be described with reference to FIGS. 5 to 17. In the present embodiment, the communication device including a plurality of protocol processors 2 will be described. FIG. 5 is a diagram illustrating a logical connection relationship in the communication device according to the present embodiment. In the example in FIG. 5, the communication device includes three protocol processors 2A, 2B, and 2C. However, the communication device in the present embodiment may include two protocol processors or four or more protocol processors.

Operations of the communication device according to the present embodiment are basically identical with those in the first embodiment. However, the present embodiment differs from the first embodiment in operations of the classifier 5, entries stored in a LUT and a referring method thereto.

First, operations of the classifier 5 will be described. In the first embodiment, the classifier 5 determines whether a packet is processed by the processor 1 or the protocol processor 2. In contrast, in the present embodiment, the classifier 5 determines whether a packet is processed by the processor 1 or any of the protocol processors 2A to 2C.

In the first embodiment, the classifier 5 notifies a packet only once. In contrast, in the present embodiment, the classifier 5 can notify a packet a plurality of times. The reason for this is that two or more protocol processors 2 can perform protocol processing on one packet because a protocol generally has a hierarchy structure.

Here, operations of the classifier 5 will be specifically described. Hereinafter, an example where the communication device receives a packet Y illustrated in FIG. 6 is described. As illustrated in FIG. 6, the packet Y has an IP header, an IPsec header, and a L2TPv3 header. It is assumed that the protocol processor 2A is an encryption processing engine, the protocol processor 2B is a tunnel process engine, and the protocol processor 2C is a TCP engine.

When the communication device receives the packet Y, the classifier 5 scans the packet Y stored in the RAM 3, acquires classification information of the packet Y, and searches for an entry corresponding to the packet Y. The classifier 5 notifies to the protocol processor 2A the packet Y and additional information to be used by the protocol processor 2A.

For example, additional information to be notified here is SPI (Security Parameters Index) for specifying SA (Security Association) required for processing of IPsec. At this time, a part or the whole of the packet remains encrypted, information subsequent to the L2TPv3 header cannot be acquired. When the classifier 5 fails to find out an entry corresponding to the packet Y, the classifier 5 notifies the packet Y to the processor 1, as in the first embodiment.

The protocol processor 2A having received the notification of the packet Y performs decoding processing on the packet Y using the notified additional information. Accordingly, the packet Y becomes a L2TPv3 packet. The protocol processor 2A notifies the decoded packet Y to the classifier 5.

Next, the classifier 5 having received the notification from the protocol processor 2A notifies, to the protocol processor 2B, the packet Y having been processed by the protocol processor 2A and additional information to be used by the protocol processor 2B. Additional information to be notified here is information for identifying L2TPv3 tunnel management information (e.g., a session ID), for example.

The protocol processor 2B having received the notification of the packet Y processes the packet Y using the notified additional information. That is, the protocol processor 2B decapsulates the packet Y in accordance with L2TPv3 tunnel. The protocol processor 2B notifies the decapsulated packet Y to the classifier 5.

Further, the classifier 5 having received the notification from the protocol processor 2B notifies to the processor 1 the packet Y having been processed by the protocol processor 2B. The processor 1 having received the notification of the packet Y determines whether the packet Y is addressed to its own node. When the packet Y is not addressed to its own node, the processor 1 may transmit the packet Y to a destination node, or may end the processing. Whether the packet Y is addressed to its own node may be determined by the classifier 5.

In this way, in the present embodiment, the classifier 5 notifies, to the protocol processors 2 a plurality of times, a packet received by the communication device together with additional information corresponding to the respective protocol processors 2.

The classifier 5 may determine which protocol processor 2 receives the notification of a packet, based on the number of times of notifications (the number of times of performing processing by the protocol processor 2), for example.

The number of times of performing processing may be managed by the classifier 5, or may be managed by the classifier 5 and the protocol processor 2 in collaboration. Examples of a management method of the number of times of performing processing includes a method of notifying a descriptor including a counter, which indicates the number of performing processing, to the protocol processor 2 when the classifier 5 notifies a packet and additional information to the protocol processor 2. Each time the protocol processor 2 processes the packet, the counter is changed (incremented or decremented). Accordingly, the number of performing processing can be known. The counter may be changed by the classifier 5 or the protocol processor 2 that has processed the packet.

The case where the protocol processors 2A and 2B process IPsec and L2TPv3, respectively, has been described above. However, in the present embodiment, a combination of protocols with which the respective protocol processors 2 perform processing is arbitrary. Examples of the combination include a combination of IPsec (transport mode) and TCP, a combination of GRE and IPv6 datagram, a combination of TCP and SSL/TLS, and a combination of UDP and DTLS.

Next, entries in the present embodiment will be described.

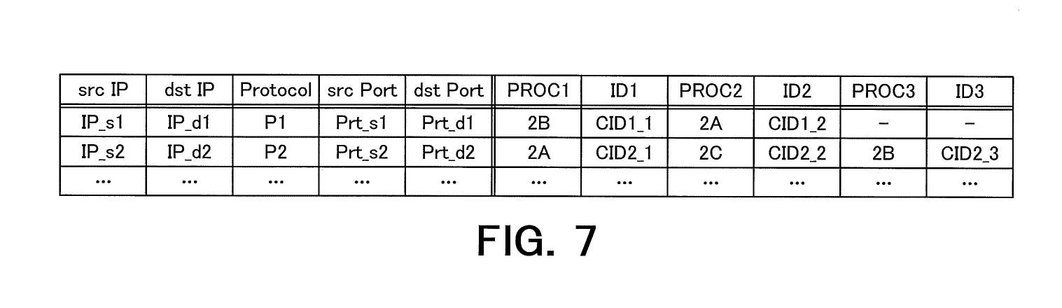

FIG. 7 illustrates a diagram showing an example of entries in the present embodiment. In the example in FIG. 7, with additional information, an identifier of a corresponding protocol processor 2 to use the additional information is associated. Each entry includes the classification information (src IP, dst IP, Protocol, src Port, dst Port) of a packet, the identifiers (PROC1 to PROC3) of the protocol processors 2 that perform first to third processing on the packet, and the identifiers (ID1 to ID3) of additional information to be notified in first to third notifications.

For example, in the entry in the first line in FIG. 7, PROC1 is 2B, ID1 is CID1_1, PROC2 is 2A, ID2 is CID1_2, and PROC3 and ID3 are null. This shows that a packet corresponding to the entry is subject to first protocol processing by the protocol processor 2B and is subject to second protocol processing by the protocol processor 2A. The identifier of additional information to be notified to the protocol processor 2B is CID1_1, and the identifier of additional information to be notified to the protocol processor 2A is CID1_2.

For example, when the communication device receives a packet corresponding to the entry in the first line in FIG. 7, the classifier 5 first refers to the entry in the first line in FIG. 7 and notifies the packet and the identifier (CID1_1) of additional information to the protocol processor 2B.

Next, the classifier 5 having received a notification of the packet from the protocol processor 2B refers again to the entry in the first line stored in a predetermined region and notifies the packet and the identifier (CID1_2) of additional information to the protocol processor 2A.

In the entry in the first line in FIG. 7, an ID of a protocol processor 2 to perform third processing and an identifier of additional information therefor is not set. Thus, after the protocol processor 2A processes the packet, the packet processing to be performed by the communication device ends.

As described above, in the present embodiment, the identical entry is repeatedly referred to. Thus, the classifier 5 preferably stores, in a predetermined region (e.g., a cash entry) in the LUT RAM 6, an entry corresponding to a packet which is found out as a result of searching of the LUT. Accordingly, repeated searching of the LUT for referring to the identical entry is not required, and thus, overhead in processing can be reduced.

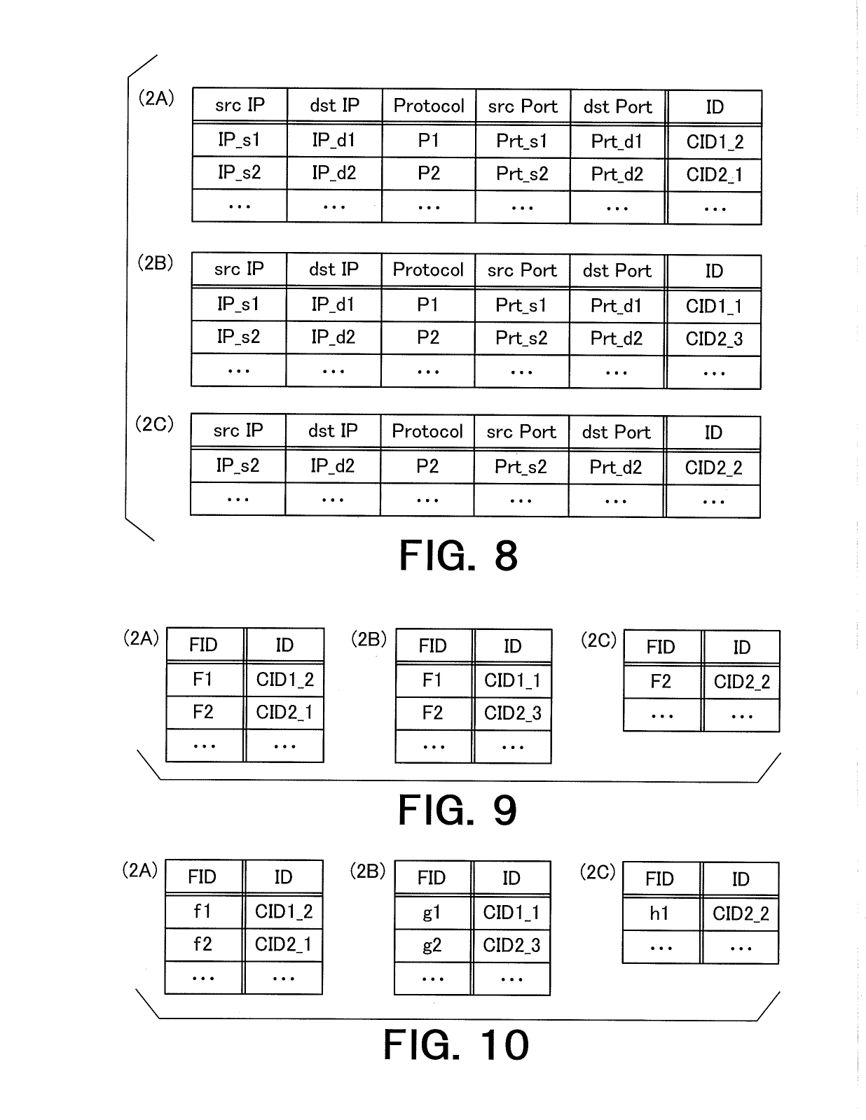

FIG. 8 is a diagram showing another example of entries in the present embodiment. The entries in FIG. 8 correspond to the entries in FIG. 7. In the example in FIG. 8, a LUT is provided for each protocol processor 2. Entries in each LUT include packet classification information (src IP, dst IP, Protocol, src Port, dst Port) and identifiers (IDs) of additional information to be notified to the protocol processors 2.

For example, in the entry in the first line in the LUT for the protocol processor 2A, ID is CID1_2. In the entry in the first line in the LUT for the protocol processor 2B, ID is CID1_1.

When using the entries in FIG. 8, the classifier 5 may select a LUT to be referred to depending on the number of times of performing processing, and search the selected LUT for an entry matching the classification information of a packet.

In the case of using IPsec or a tunnel protocol, identification information which the classifier 5 first recognizes may be different from identification information which the classifier 5 recognizes after protocol processing. For example, in the case of using IPsec, a header related to IPsec disappears due to decoding, and a plain text packet can be referred to. Thus, for example, a TCP header or a UDP header can be referred to.

In order to address such a situation, the entries in FIG. 8 may be configured such that one entry is referred to for one received packet, or may be configured such that different entries are referred to depending on change of identification information. When the entries are configured such that one entry is referred to for one received packet, a field to be used for identification may be adjusted depending on the number of times of performing processing, etc.

FIG. 9 is a modification of FIG. 8. In the example in FIG. 9, an identifier FID that is unique to the whole communication device and does not depend on a packet format is used, instead of classification information which may change depending on a stage of packet processing.

For example, the classifier 5 may refer to a header of a packet, etc. and set an identifier FID. A set identifier FID may be stored in a region of a packet which is not influenced by protocol processing, or may be included in information (a descriptor, etc.) exchanged between the classifier 5 and the protocol processors 2 together with a packet.

In the example in FIG. 9, identifiers FID are common in the LUTs. However, as shown in FIG. 10, identifiers FID may not be common in the LUTs. In the example in FIG. 10, identifiers FID do not depend on the format of a packet and are values unique to the respective protocol processors 2.

Since the entries in FIG. 7 include the order of the protocol processors 2 to process a packet, the classifier 5 can determine which protocol processor 2 a packet is to be notified to on the basis of the number of times of performing processing on a packet. However, unlike the entries in FIG. 7, the entries in FIGS. 8 to 10 do not include an order of the protocol processors 2 to process a packet. Thus, the classifier 5 cannot determine which protocol processor 2 a packet is to be notified to even if referring to the LUT.

Therefore, when using the entries in FIGS. 8 to 10, the classifier 5 may select a protocol processor 2 to which a packet is to be notified by referring to the packet. For example, the classifier 5 may select a protocol processor 2 by referring to the protocol field of a packet, or may select a protocol processor 2 by analyzing the header region of a packet.

In addition, the number of times of performing processing may be added to classification information in each entry, instead of selection of a protocol processor 2 performed by the classifier 5. Accordingly, the classifier 5 can search for an appropriate entry according to the number of times of performing processing.

The entries in the present embodiment described above are created by a method identical to that in the first embodiment. That is, the processor 1 processes a packet having no corresponding entry, creates an entry on the basis of classification information and additional information of the packet obtained during the processing, and stores the entry in the LUT.

In the present embodiment, in packet processing performed by the processor 1, some steps that can be performed by the protocol processors 2 are specified in advance. Therefore, the processor 1 can create an entry for each protocol processor 2 corresponding to packet processing performed by the processor 1.

For example, when the processor 1 performs packet processing on a packet corresponding to the entry in the first line in FIG. 7, the processor 1 performs protocol processing that can be performed by the protocol processor 2B and protocol processing that can be performed by the protocol processor 2A.

Subsequently, the processor 1 creates an entry (i.e., the entry in the first line in FIG. 7) including classification information of the packet, the identifier (2B) of the protocol processor 2B to perform first processing, the identifier (CID1_1) of additional information to be used by the protocol processor 2B, the identifier (2A) of the protocol processor 2A to perform second processing, and the identifier (CID1_2) of additional information to be used by the protocol processor 2A.

In the case of entries having the format in FIG. 7, the processor 1 may create an entry after the whole packet processing is completed, or may update an entry each time processing that can be performed by any of the protocol processors 2 is completed.

In the case of entries having the format in FIGS. 8 to 10, the processor 1 may add an entry to the LUTs for the respective protocol processors 2 each time processing that can be performed by any of the protocol processors 2 is completed.

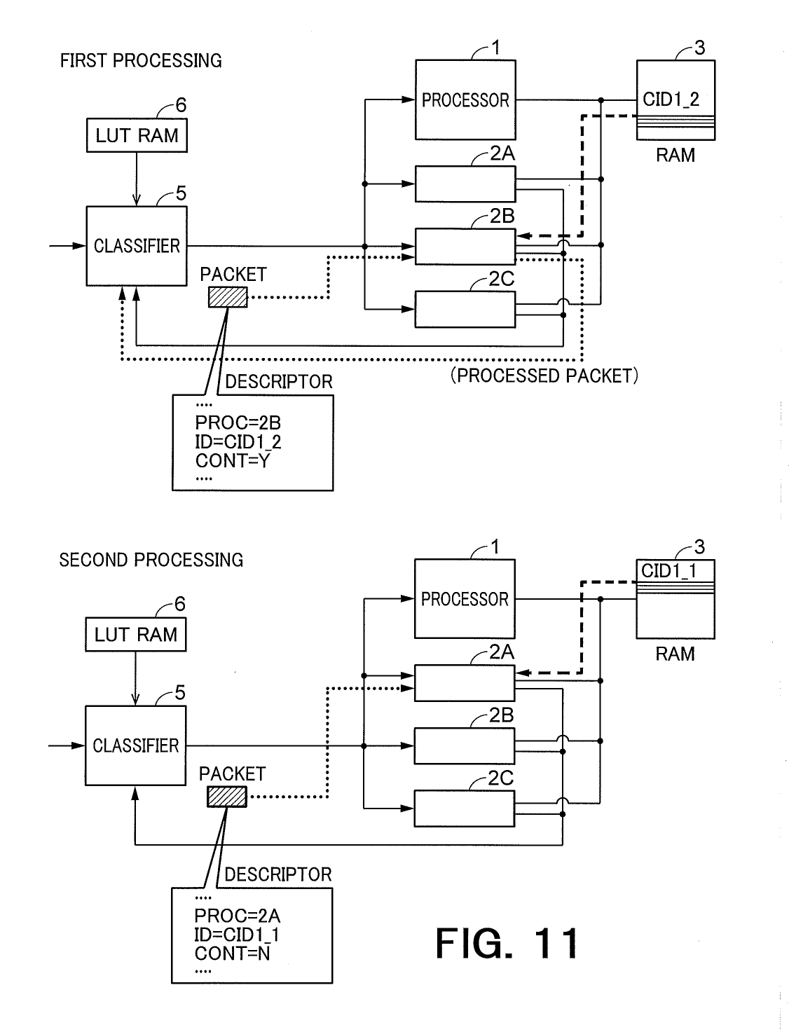

An additional information notification method used by the classifier 5 will be specifically described with reference to FIGS. 11 to 13. Hereinafter, two notification methods will be described.

As a first method, a method for notifying a plurality of pieces of additional information one by one is possible. In this method, the classifier 5 writes the identifiers of pieces of additional information used by the respective protocol processors 2 in descriptors to be notified to the protocol processors 2. Each protocol processor 2 may acquire additional information on the basis of the notified identifier of additional information, perform protocol processing on a packet, and notify the processed packet to the classifier 5.

In the first method, a timing of ending the processing can be determined according to the number of times of performing processing. More specifically, the classifier 5 may write a counter indicating the number of times of performing processing in a descriptor, change the counter each time the protocol processor 2 performs processing, and determine whether the counter reaches the number for ending. As described above, the classifier 5 having received a notification from a protocol processor 2 may change the counter, or a protocol processor 2 having performed processing may change the counter.

The number for ending may be acquired from an entry corresponding to a packet. In the case of an entry having the format in FIG. 7, the number for ending is the number of the identifiers of protocol processors 2 included in the entry. For example, since the entry in the first line in FIG. 7 includes two identifiers of protocol processors 2, the number for ending is set to “2” for a packet corresponding to the entry.

In the case of an entry having the format in FIGS. 8 to 10, the number for ending is the number of entries corresponding to a packet. For example, in the case of a packet corresponding to the entry in the first line in FIG. 8, since two entries correspond to the packet, the number for ending is “2”.

Determination of a timing for ending processing may be performed by a protocol processor 2. In order to achieve this, a method of using a flag indicating to end or continue processing is possible. The classifier 5 may write a flag in a descriptor, etc., and a protocol processor 2 having received the notification of the descriptor may determine whether to end the processing according to the flag. The flag may be changed by the classifier 5 depending on the number of times of performing processing.

In the first method, the classifier 5 may write in a descriptor, the ID of a protocol processor 2 to perform the next processing on a packet, information for specifying an entry to be referred to, and the like, together with the number of times of performing processing and a flag. Accordingly, overhead in processing due to searching for or referring to an entry by the classifier 5 can be reduced.

FIG. 11 is a diagram illustrating an example of the first method. In the example in FIG. 11, in the first processing, the classifier 5 notifies a packet and a descriptor to the protocol processor 2B. In the descriptor, the identifier (PROC=2B) of the protocol processor 2B and the identifier (ID=CID1_2) of additional information are written, and a continue flag (CONT=Y) is set. The continue flag (CONT=Y) indicates to continue the processing.

The protocol processor 2B having received the notification from the classifier 5 acquires additional information on the basis of the identifier CID1_2 of additional information and performs protocol processing. Since the continue flag is set, the protocol processor 2B notifies the processed packet to the classifier 5.

In the second processing, the classifier 5 notifies the packet and a descriptor to the protocol processor 2A. In the descriptor, the identifier (PROC=2A) of the protocol processor 2A and the identifier (ID=CID1_1) of additional information are written, and a continue flag (CONT=N) is cleared. The cleared continue flag (CONT=N) indicates to end the processing.

The protocol processor 2A having received the notification from the classifier 5 acquires additional information on the basis of the identifier CID1_1 of additional information and performs protocol processing. Since the continue flag is cleared, the protocol processor 2A ends the processing without notifying the processed packet to the classifier 5.

In the example in FIG. 11, the packet is exchanged between the classifier 5 and the protocol processors 2. However, instead of a packet, the identifier of a packet may be notified. For example, the identifier of a packet may be written in a descriptor. A protocol processor 2 having received the notification of the descriptor can acquire the packet on the basis of the identifier of the packet written in the descriptor.

In the example in FIG. 11, a descriptor is exchanged between the classifier 5 and the protocol processors 2. However, the descriptor may be stored in the RAM 3. The classifier 5 and the protocol processors 2 may use, as a queue, a particular secured region on the RAM 3, and sequentially refer to descriptors stored therein.

The classifier 5 may use registers in protocol processors 2 or use interruption signals in order to notify the existence of a descriptor to the protocol processors 2. In order to achieve this, an appropriate method may be selected according to the implementation.

When a descriptor is stored in the RAM 3, a corresponding protocol processor 2 is specified depending on where the descriptor is written. Thus, the identifier (PROC) of a protocol processor 2 does not need to be written in the descriptor.

The first method described above may be performed by using a packet instead of a descriptor. The classifier 5 may write information such as the identifier of additional information, the number of times of performing processing, and a flag in an available region (a processed region or an unused region) of a packet that does not receive any influence by processing, and notifies the packet to a protocol processor 2.

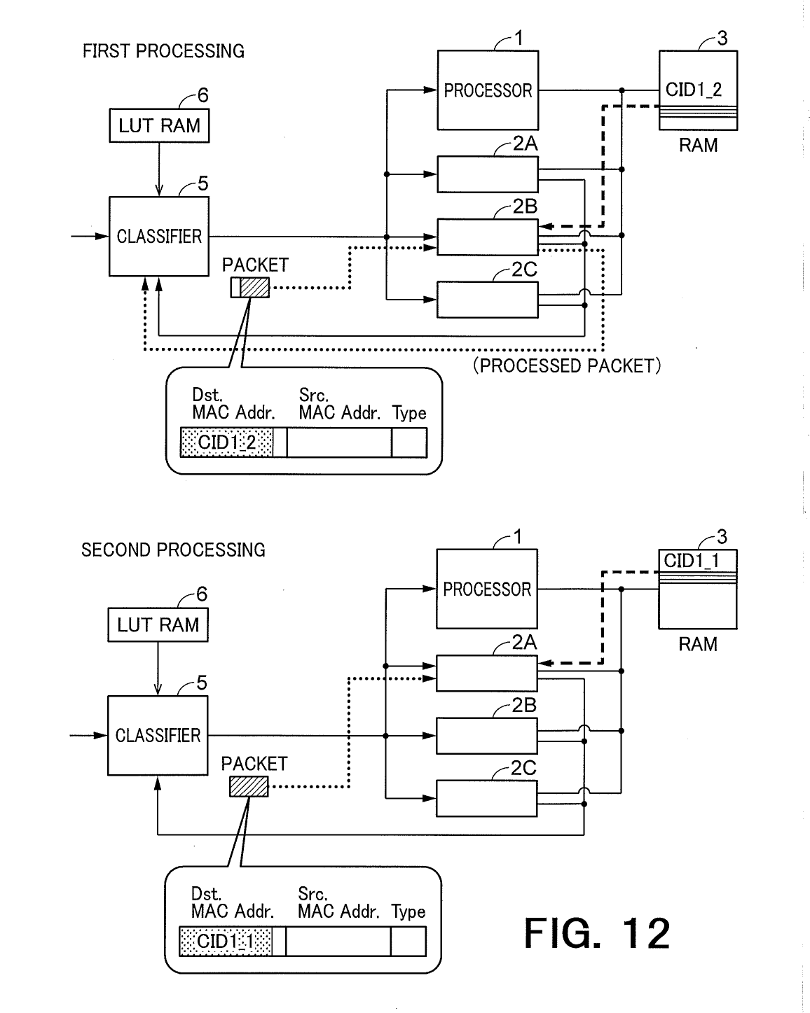

FIG. 12 is a diagram illustrating another example of the first method using an available region of a packet. In the example in FIG. 12, the identifier of additional information is written in the destination MAC address (Dst MAC Addr) of a packet. A protocol processor 2 having received the notification of the packet can acquire information such as the identifier of additional information with reference to the packet.

As a second method, a method for notifying a plurality of pieces of additional information collectively is possible. In this method, the classifier 5 collectively writes the identifiers of pieces of additional information to be used by respective protocol processors 2, in a descriptor to be notified to the protocol processors 2. The classifier 5 may write, in the descriptor, the identifiers of the protocol processors 2 together with the identifiers of additional information. Each protocol processor 2 selects the identifier of additional information to be used by its own node, from the notified descriptor. The protocol processor 2 may acquire additional information on the basis of the selected identifier of additional information, perform protocol processing on a packet, and notify the processed packet to the classifier 5.

When an entry having the format in FIG. 7 is stored in the LUT, the classifier 5 may collectively write in a descriptor the identifiers (ID1 to ID3) of additional information included in the entry. When an entry having the format in FIGS. 8 to 10 is stored in each LUT, the classifier 5 may scan a packet, specify a plurality of entries corresponding to the packet, and collectively write in a descriptor the identifiers of additional information included in the entries.

As a method of writing the IDs of a plurality of protocol processors 2 and the identifiers of additional information in a descriptor, a method of writing the IDs of the protocol processors 2 and the identifiers of additional information so as to be simply arranged side by side, and a method of writing the IDs of the protocol processors 2 and the identifiers of additional information so as to be arranged into a stack-like form by considering the order of performing protocol processing, etc. are possible.

Each protocol processor 2 may select the identifier of additional information to be used by its own node with reference to the identifiers of protocol processors 2 written in a descriptor, or may separately receive a notification of the identifier of additional information from the classifier 5. The classifier 5 may write in a descriptor a number indicating a written order of the identifier of additional information to be used by each protocol processor 2.

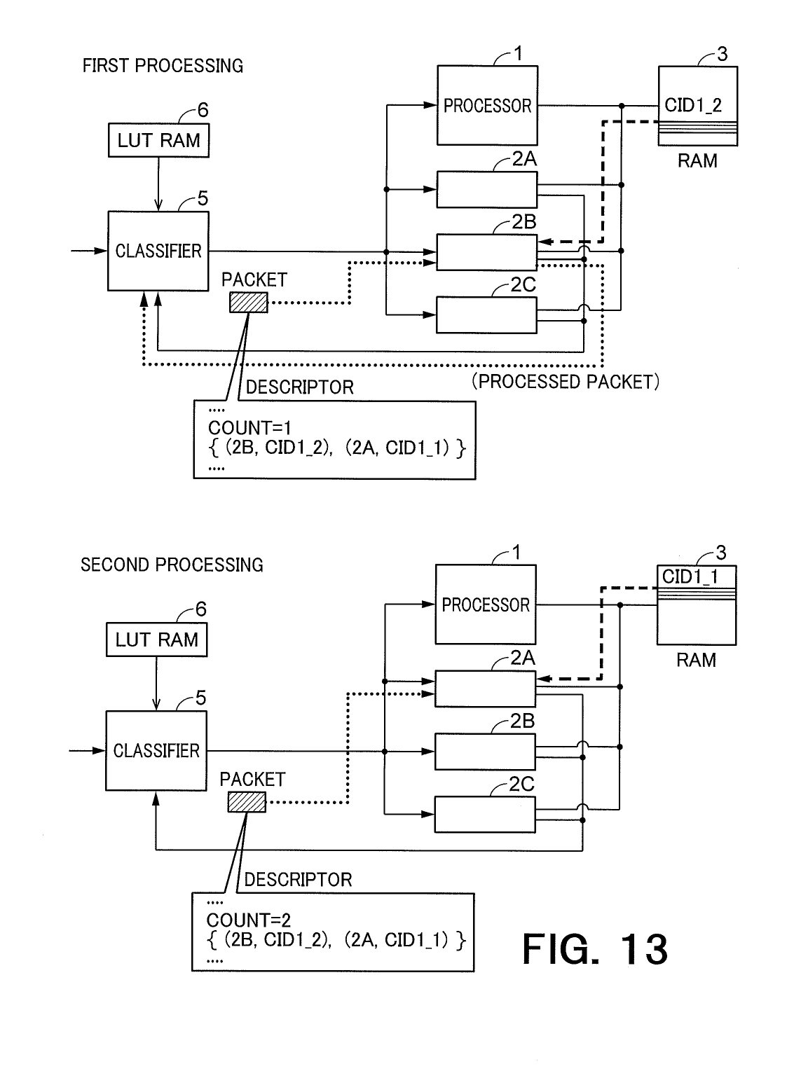

FIG. 13 is a diagram illustrating an example of the second notification method. In the example in FIG. 13, the IDs of protocol processors 2 and the identifiers of additional information are written in a descriptor to be notified from the classifier 5 to the protocol processors 2 such that the identifiers are arranged in a stack-like form in accordance with the processing order. In the descriptor, numbers (COUNT) indicating written orders of the identifiers of additional information to be used by the protocol processors 2 are written. In the example in FIG. 13, since the COUNT of the protocol processor 2B is “1”, the protocol processor 2B acquires additional information on the basis of the identifier (CID1_2) which is written at the first site (i.e., first item) in the descriptor.

The numbers COUNT written in the descriptor may be changed each time the classifier 5 receives the notification of a processed packet by a protocol processor 2, or may be changed by a protocol processor 2 that has completed processing.

When the number COUNT is changed by a protocol processor 2, the protocol processor 2 does not need to return a processed packet to the classifier 5. In this case, the protocol processor 2 may notify the processed packet to a protocol processor 2 which is specified by the identifier written at a site indicated by the changed number.

For example, in the example in FIG. 13, after the protocol processor 2B completes first processing, the protocol processor 2B changes the number COUNT to “2”. The protocol processor 2B may refer to the identifier (2A) of a protocol processor 2 which is written at the second site in the descriptor, and notify the processed packet to the protocol processor 2A.

Each protocol processor 2 may refer to the identifier of additional information written at the first site in a descriptor. In this case, each time the classifier 5 receives the notification of a packet from the protocol processor 2, the classifier 5 may change the order of identifiers of additional information according to the number of times of performing processing. The second method can be performed by using an available region of a packet instead of using a descriptor, as in the first method.

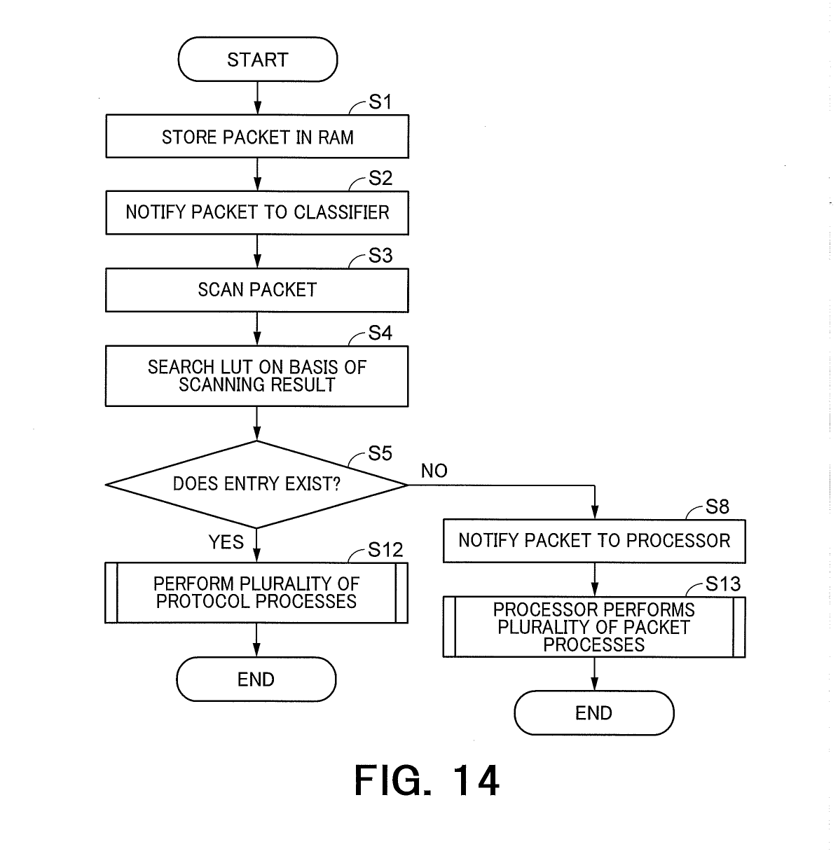

Next, operations of the communication device according to the present embodiment will be described with reference to FIGS. 14 to 17. FIG. 14 is a flowchart showing operations of the communication device according to the present embodiment when the device receives a packet. Steps S1 to S5 and S8 in the flowchart in FIG. 14 are identical to those in FIG. 3.

In the present embodiment, when the classifier 5 finds out an entry corresponding to a packet (Yes at Step S5), a plurality of protocol processors 2 perform protocol processing (Step S12). When the classifier 5 fails to find out an entry corresponding to a packet (No at Step S5) and notifies the packet to the processor 1, the processor 1 performs a plurality of packet processes (Step S13). Hereinafter, Steps S12 and S13 will be described.

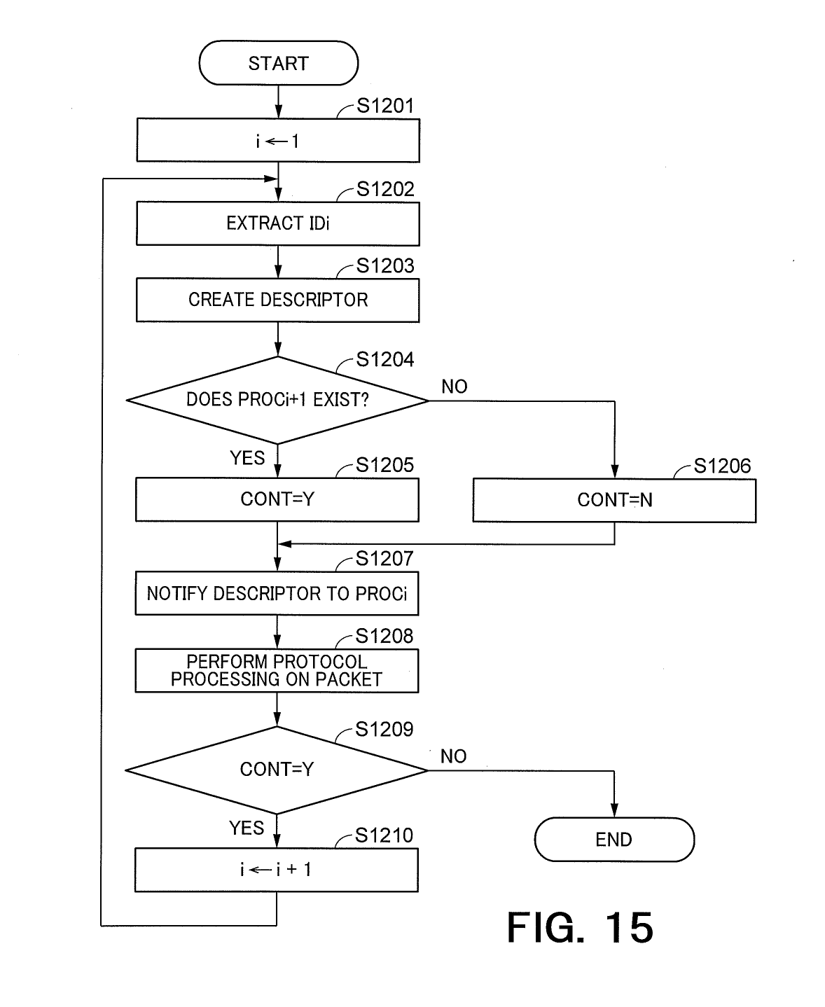

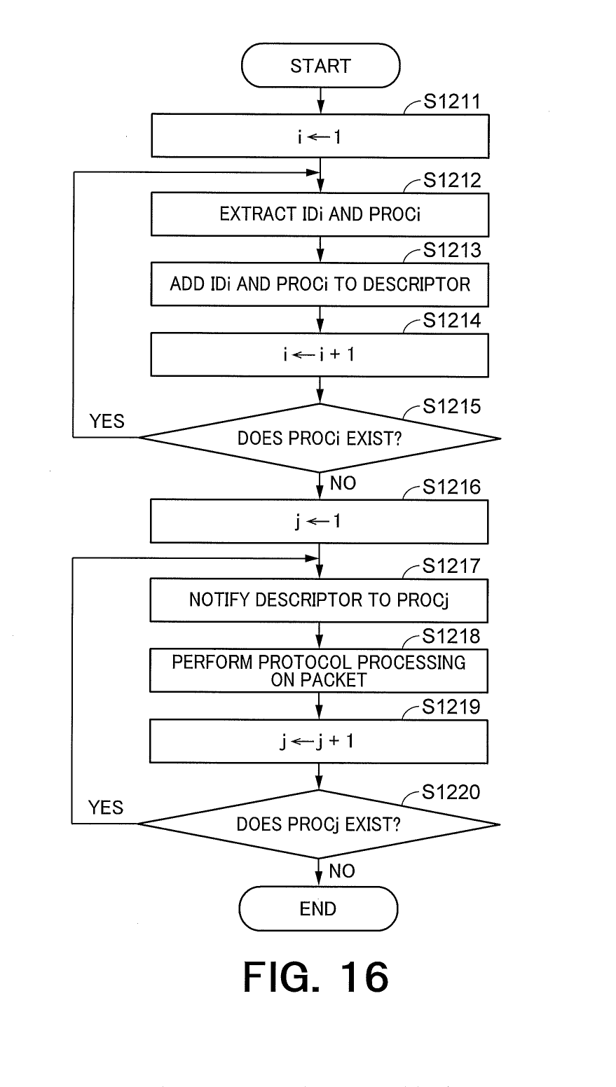

FIG. 15 is a flowchart showing an example of protocol processing performed by a plurality of protocol processors 2. The flowchart in FIG. 15 corresponds to Step S12 in FIG. 14. In the processing in FIG. 15, the identifiers of additional information are notified one by one. An entry is assumed to have the format in FIG. 7, in the description below.

First, the classifier 5 sets a counter “i” to “1” (Step S1201).

Next, the classifier 5 extracts the identifier (IDi) of additional information at the i-th site from an entry corresponding to a packet (Step S1202).

Next, the classifier 5 creates a descriptor including the extracted identifier of additional information (Step S1203). In the descriptor, a flag CONT is set, as in FIG. 11.

Next, the classifier 5 determines whether a protocol processor 2 (PROCi+1) site exists at the i+1-th in the entry corresponding to the packet (Step S1204). When PROCi+1 exists (Yes at Step S1204), the classifier 5 sets the CONT in the descriptor to “Y”. (Step S1205). When PROCi+1 does not exist (No at Step S1204), the classifier 5 sets the flag CONT in the descriptor to an end flag “N” (Step S1206). Subsequently, the classifier 5 notifies the descriptor to the protocol processor 2 (PROCi) at the i-th site (Step S1207).

The protocol processor 2 having received the notification from the classifier 5 acquires additional information by using the identifier of additional information included in the descriptor and performs protocol processing on the packet (Step S1208).

After performing the protocol processing, the protocol processor 2 determines whether the flag CONT in the descriptor is an end flag “Y” (Step S1209). When CONT=Y (Yes at Step S1209), the protocol processor 2 changes the counter “i” (Step S1210), and notifies the processed packet to the classifier 5. However, the counter “i” may be changed by the classifier 5.

When CONT=N (No at Step S1209), the protocol processor 2 ends the processing. Accordingly, the protocol processing to be performed by a plurality of protocol processors 2 ends.

For example, when the communication device receives a packet corresponding to the entry in the first line in FIG. 7, the classifier 5 sets the counter “i” to “1” (Step S1201), extracts the identifier CID1_1 of additional information (Step S1202), and creates a descriptor including the identifier CID1_1 (Step S1203).

Since PROC2 exists in the entry in the first line in FIG. 7 (Yes at Step S1204), the classifier 5 sets the CONT in the descriptor to “Y” (Step S1205), and notifies the descriptor to the protocol processor 2B (Step S1207).

The protocol processor 2B acquires additional information from the RAM 3 on the basis of the identifier CID1_1, and performs protocol processing on the packet (Step S1208). Since the CONT in the descriptor notified to the protocol processor 2B is “Y” (Yes at Step S1209), the protocol processor 2B changes the counter “i” (Step S1210) and notifies the processed packet to the classifier 5.

The classifier 5 having received the notification from the protocol processor 2B extracts the identifier CID1_2 of additional information (Step S1202) and creates a descriptor including the identifier CID1_2 (Step S1203).

Since PROC3 does not exist in the entry in the first line in FIG. 7 (No at Step S1204), the classifier 5 sets the flag CONT in the descriptor to an end flag “N” (Step S1206) and notifies the descriptor to the protocol processor 2A (Step S1207).

The protocol processor 2A acquires additional information from the RAM 3 on the basis of the identifier CID1_2, and performs protocol processing on the packet (Step S1208). Since the flag CONT in the descriptor notified to the protocol processor 2A is the flag “N” (No at Step S1209), the protocol processor 2A ends the processing after completing the protocol processing.

As described above, notification of pieces of additional information one by one allows a plurality of protocol processors 2 to perform protocol processing.

FIG. 16 is a flowchart showing another example of protocol processing to be performed by a plurality of protocol processors 2. The flowchart in FIG. 16 corresponds to Step S12 in FIG. 14. In the processing in FIG. 16, identifiers of additional information are notified collectively. An entry is assumed to have the format in FIG. 7, in the description below.

First, the classifier 5 sets a counter “i” to “1” (Step S1211). Next, the classifier 5 extracts the identifier (IDi) of additional information and the protocol processor (PROCi) at the i-th site from an entry corresponding to a packet (Step S1212).

Next, the classifier 5 adds to a descriptor the extracted identifier of additional information and the extracted protocol processor 2 (Step S1213) and changes the counter “i” (Step S1214).

Next, the classifier 5 determines whether a protocol processor 2 (PROCi) exists at the i-th site in the entry corresponding to the packet (Step S1215). When PROCi exists (Yes at Step 1215), the processing returns to Step S1212.

When PROCi does not exist (No at Step 1215), the classifier 5 sets the counter “j” to “1” (Step S1216) and notifies the descriptor to the j-th protocol processor 2 (PROCj) (Step S1217).

The protocol processor 2 having received the notification of the descriptor acquires additional information on the basis of the j-th identifier of additional information in the descriptor, performs protocol processing on the packet (Step S1218), and changes the counter “j” (Step S1219).

Subsequently, the protocol processor 2 determines whether a protocol processor 2 (PROCj) exists at the j-th site in the descriptor (Step S1220). When. PROCj exists (Yes at Step 1220), the processing returns to Step S1217. When PROCj does not exist (No at Step 1220), the processing ends.

For example, the communication device receives a packet corresponding to the entry in the first line in FIG. 7, the classifier 5 sets the counter “i” to “1” (Step S1211), extracts the identifier CID1_1 of additional information and the ID (2B) of the protocol processor 2 at the first site (Step S1212), adds the identifier CID1_1 and the ID (2B) to a descriptor (Step S1213), and changes the counter “i” (Step S1214).

Since PROC2 exists in the entry in the first line in FIG. 7 (Yes at Step S1215), the classifier 5 extracts the identifier CID1_1 of additional information and the ID (2A) of the protocol processor 2 at the second site (Step S1212), adds the identifier CID1_1 and the ID (2A) to the descriptor (Step S1213), and changes the counter “i” (Step S1214).

Since PROC3 does not exist in the entry in the first line in FIG. 7 (No at Step S1215), the counter “j” is set to “1” (Step S1216) and the descriptor is notified to the protocol processor 2B (Step S1217).

The protocol processor 2B having received the notification of the descriptor acquires additional information from the RAM 3 on the basis of the identifier CID1_2 of additional information written at the first site in the descriptor, performs protocol processing on the packet (Step S1218), and changes the counter “j” (Step S1219).

Since the ID of the protocol processor 2 exists at the second site in the descriptor (Yes at Step S1220), the protocol processor 2B notifies the processed packet and the descriptor to the protocol processor 2A written at the second site (Step S1217).

The protocol processor 2A having received the notification acquires additional information from the RAM 3 on the basis of the identifier CID1_1 of additional information written at the second site in the descriptor (Step S1218), and changes the counter “j” (Step S1219).

Since the ID of a protocol processor 2 does not exist at the third site in the descriptor (No at Step S1220), the protocol processor 2A ends the processing after performing protocol processing on the packet.

As described above, collective notification of pieces of additional information allows a plurality of protocol processors 2 to perform protocol processing.

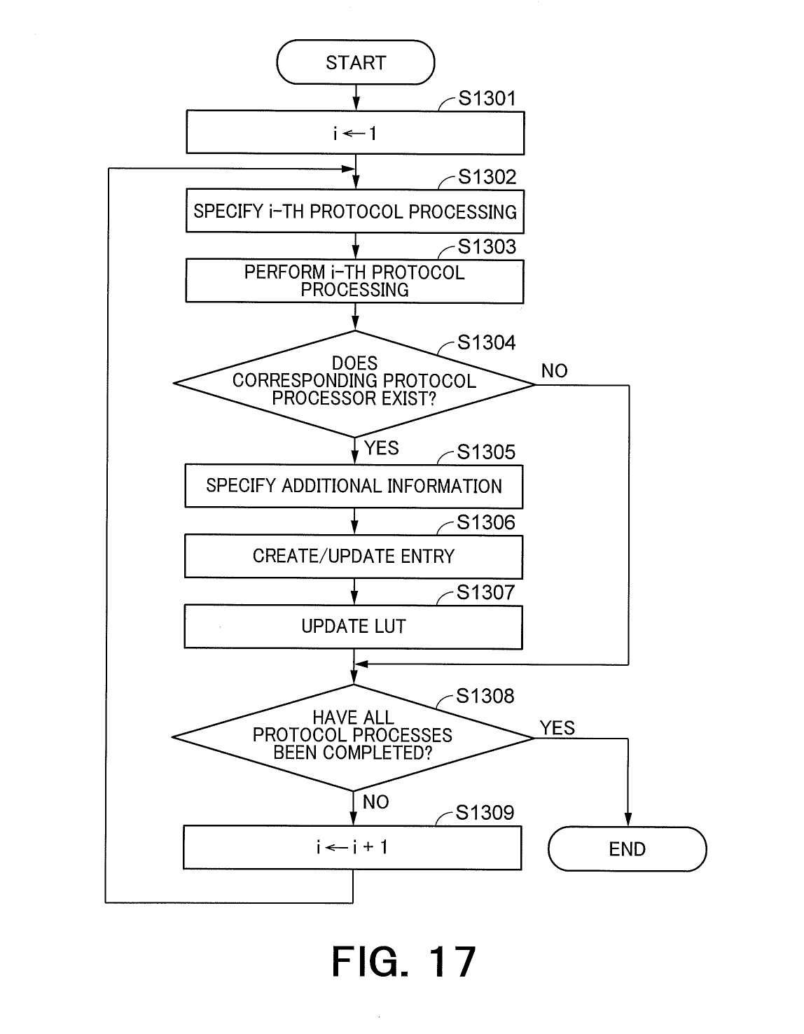

FIG. 17 is a flowchart showing an example of a plurality of protocol processes to be performed by the processor 1. The flowchart in FIG. 17 corresponds to Step S13 in FIG. 14. In the processing in FIG. 17, an entry is updated each time a protocol processing is performed.

First, the processor 1 sets the counter “i” to “1” (Step S1301).

Next, the processor 1 specifies the i-th protocol processing (Step S1302), and performs the specified i-th protocol processing (Step S1303).

After performing the protocol processing, the processor 1 determines whether a corresponding protocol processor 2, i.e., a protocol processor 2 that can perform the i-th protocol processing exists (Step S1304).

When a corresponding protocol processor 2 does not exist (No at Step S1304), the processing is advanced to Step S1308. When a corresponding protocol processor 2 exists (Yes at Step S1304), the processor 1 specifies additional information to be used by the corresponding protocol processor 2 (Step S1305).

The processor 1 adds the identifier of the specified additional information and the ID of the corresponding protocol processor 2 to an entry corresponding to the packet, thereby updating the entry (Step S1306). When an entry corresponding to the packet does not exist, the processor 1 creates an entry including classification information of the packet, and then, adds the identifier of the additional information and the ID of the protocol processor 2 to the created entry.

The processor 1 adds the updated entry to the LUT stored in the LUT RAM 6, and updates the LUT (Step S1307).

Next, the processor 1 determines whether all the protocol processes for the packet have been completed (Step S1308). When all the protocol processes have not been completed (No at Step S1308), the processor 1 changes the counter “i” (Step S1309). Subsequently, the processing returns to Step S1302.

When all the protocol processes have been completed (Yes at Step S1308), the processor 1 ends the processing. Accordingly, the plurality of protocol processes to be performed by the processor 1 end.

In the example in FIG. 17, the processor 1 updates an entry each time one protocol processing is performed. However, entries may be updated collectively after completion of all the protocol processes.

As described above, in the communication device according to the present embodiment, the classifier 5 can notify additional information to a plurality of protocol processors 2. Thus, even when the communication device includes a plurality of protocol processors 2, overhead in processing can be reduced, as in the first embodiment, and a time required for the protocol processes performed by the protocol processors 2 can be shortened.

Also in the present embodiment, entries stored in the LUT are deleted after completion of a set of communications, as in the first embodiment. However, when the entries having the format in FIGS. 8 to 10 are used, only entries corresponding to some protocol processors 2 may be deleted according to the completed communication.

Examples of the above case include a case where a communication (connection) using a certain protocol is simultaneously used by communications (connections) using a plurality of other protocols. For example, a TCP connection and a plurality of HTTP connections operated thereon, and a UDP connection and a plurality of VPN connections operated thereon are possible. In these cases, only entries for other protocols with which communications have been completed may be deleted.

### Third Embodiment

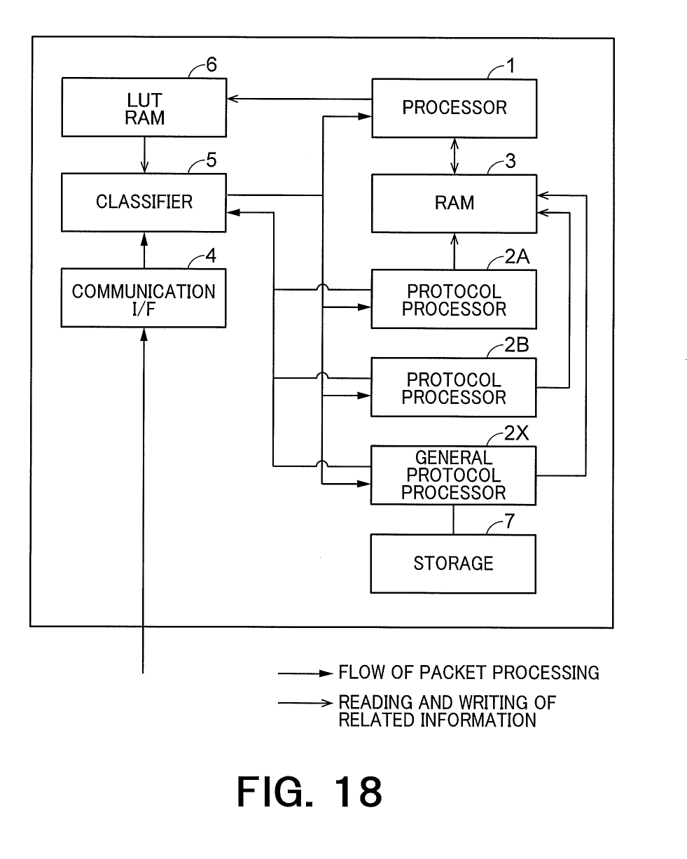

A communication device according to a third embodiment will be described with reference to FIGS. 18 to 20. In the above embodiments, the contents of protocol processing to be performed by a protocol processor 2 are determined in advance. In contrast, in the present embodiment, a case where the communication device includes a general protocol processor 2 will be described.

FIG. 18 is a diagram illustrating a logical connection relationship in the communication device according to the present embodiment. As illustrated in FIG. 18, the communication device includes a storage 7. In addition, the communication device includes a general protocol processor 2X instead of the protocol processor 2C. The other components are identical to those in the second embodiment.

The general protocol processor 2X is a protocol processor 2 which is for general. The general protocol processor 2X differs from the dedicated protocol processors 2A and 2B which perform predetermined protocol processing. The general protocol processor 2X can perform a plurality of protocol processes since protocol processing to be performed by the general protocol processor 2X is not determined in advance.

The general protocol processor 2X performs a plurality of protocol processes by changing software to be executed or changing the execution logic of hardware, similar to a dynamic reconfigurable processor or an FPGA. The communication device may include a plurality of general protocol processors 2.

The storage 7 is used by the general protocol processor 2X. The storage 7 stores therein software to be executed by the general protocol processor 2X, logic configuration data, and the like. The storage 7 may be shared by the storage (for example, the RAM 3) used by the processor 1, or may be dedicated for the general protocol processor 2X. Alternatively, the storage 7 may be constituted of a dedicated storage and a shared storage.

Here, entries in the present embodiment will be described. In the present embodiment, an entry for the general protocol processor 2X includes information (hereinafter, “program identifier”) for specifying a protocol processing to be performed by the general protocol processor 2X and additional information required for the specified protocol processing. The program identifier is associated with additional information to be used in the protocol processing.

The program identifier includes an identifier for specifying a program, a function, an API (Application Programming Interface), etc., to be executed by the general protocol processor 2X. As the program identifier for specifying a program, a program name, the name of a file storing the program, an entry point (an address in the storage 7 in which the program is stored) of the program, or the like is used, for example. As the program identifier for specifying a function, a function name, an entry point of the function, or the like is used. As the program identifier for specifying an API, an API name, an entry point of the API, or the like is used.

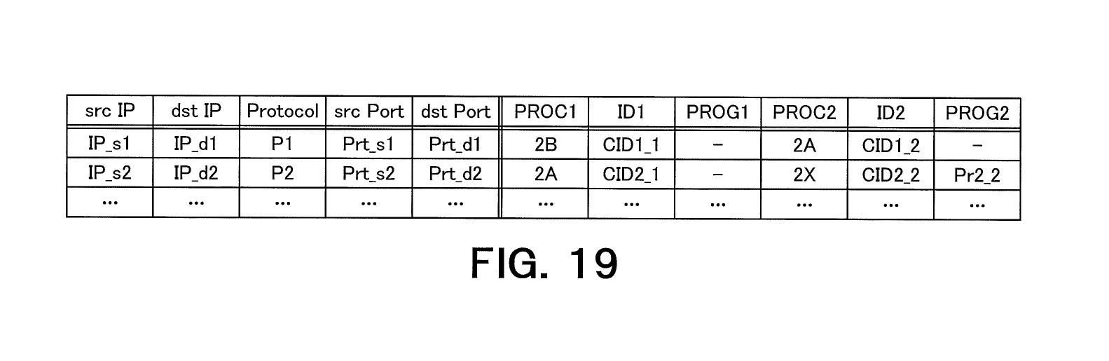

FIG. 19 is a diagram showing an example of entries in the present embodiment. The entries in FIG. 19 correspond to the entries in FIG. 7 in the present embodiment. In the example in FIG. 19, fields “PROG1” and “PROG2” are added to each entry. In each of these fields, a program identifier is stored. For example, in the entry in the second line in FIG. 19, PROC2 is 2X, ID2 is CID2_2, and PROG2 is Pr2_2. This shows that the general protocol processor 2X performs protocol processing specified by the program identifier Pr2_2 by using additional information specified by the identifier CID2_2.

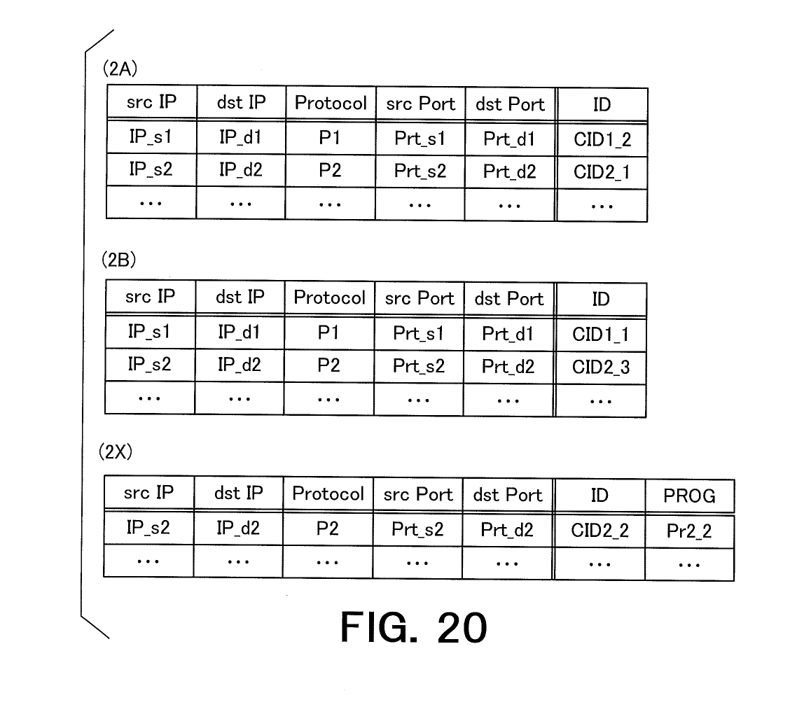

FIG. 20 is a diagram showing another example of entries in the present embodiment. The entries in FIG. 20 correspond to the entries in FIG. 8 in the first embodiment. The LUTs for the protocol processors 2A and 2B in FIG. 20 are similar to those in FIG. 8. In the example in FIG. 20, a field “PROG” is added to the LUT for the protocol processor 2X. In this filed, a program identifier is stored. For example, in the entry in the first line for the general protocol processor 2X in FIG. 20, ID is CID2_2, and PROG is Pr2_2. This shows that the general protocol processor 2X performs protocol processing specified by the program identifier Pr2_2 by using additional information specified by the identifier CID2_2.

A program identifier stored in an entry is notified together with the identifier of additional information to the general protocol processor 2X by the classifier 5. The classifier 5 can use a descriptor or an available region of a packet to notify the program identifier. A method for notifying a program identifier may be same as or different from the method of notifying the identifier of additional information.

In the present embodiment, a program identifier is preferably stored in the RAM 3 such that the program identifier is associated with packet processing to be performed by the processor 1. More specifically, an entry including an identifier for specifying a packet processing to be performed by the processor 1 and a corresponding program identifier is preferably stored in the RAM 3. Accordingly, when the processor 1 performs a protocol processing which can be performed by the general protocol processor 2X, the processor 1 can acquire a program identifier corresponding to the protocol processing and add the program identifier to the entry in the LUT.

Here, operations of the communication device according to the present embodiment when the device receives a packet will be described. Operations when the device receives a packet in the present embodiment are substantially same as those in the second embodiment. However, the present embodiment differs from the second embodiment in operations for changing a protocol processing to be performed by the general protocol processor 2X.

The reason for this is that, when a protocol processing to be performed by the general protocol processor 2X is changed, overhead in processing occurs because the general protocol processor 2X needs to load a new program or rewrite an execution circuit. Such overhead may cause reduction in processing efficiency or delay in the protocol processing to be performed by the general protocol processor 2X.

Therefore, in the present embodiment, the communication device operates so as to suppress delay which occurs when a protocol processing to be performed by the general protocol processor 2X is changed. More specifically, the following operations are possible.

Here, a protocol processing being currently performed by the general protocol processor 2X is referred to as a protocol processing A, and another protocol processing which can be performed by the general protocol processor 2X is referred to as a protocol processing B. When the communication device receives a packet having no corresponding entry, the packet is notified to the processor 1 by the classifier 5, and is processed by the processor 1. When the processor 1 performs the protocol processing B on the packet, the processor 1 notifies a program identifier corresponding to the protocol processing B to the general protocol processor 2X. The general protocol processor 2X having received the notification of the program identifier prepares for performing the protocol processing B. That is, the general protocol processor 2X loads a program or rewrites an execution circuit, according to the notified program identifier. The program identifier to the general protocol processor 2X may be notified by the classifier 5.

The classifier 5 causes the processor 1 to process a packet having same classification information as the above packet until the general protocol processor 2X completes the preparation. Completion of preparation may be notified from the general protocol processor 2X to the classifier 5. Alternatively, a time required for completion of preparation may be set in advance and be stored in the LUT RAM 6 or the RAM 3.

After the general protocol processor 2X completes the preparation, the classifier 5 notifies to the general protocol processor 2X a packet having same classification information as the above packet. Next, the general protocol processor 2X performs the protocol processing B on the notified packet.

Through the above operations, a waiting time for packet processing is not generated, and thus, delay in changing of a protocol processing to be performed by the general protocol processor 2X can be suppressed.

In the above descriptions, at a time point at which a packet on which a protocol processing B is to be performed is received, the general protocol processor 2X has started to prepare for the protocol processing B. However, a timing for starting the preparation is not limited thereto. For example, the general protocol processor 2X may start the preparation when the communication device has received continuously a predetermined number of packets on which the protocol processing B is to be performed. Accordingly, the number of times of changing a protocol, processing to be performed by the general protocol processor 2X can be reduced so that delay due to change of a protocol processing can be reduced.

As described above, in the communication device according to the present embodiment, the classifier 5 can notify to the general protocol processor 2X additional information corresponding to a protocol processing to be performed by the general protocol processor 2X. Thus, even when the communication device includes the general protocol processor 2X, overhead in processing can be reduced and a time required for protocol processes to be performed by protocol processors 2 can be shortened, as in the first embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A classifier arranged in a communication device including at least one protocol processor that performs a predetermined processing on a received packet, the classifier comprising:
processing circuitry being configured to specify the protocol processing to be performed on the packet on the basis of classification information of the packet; and notify the packet and additional information used for performing the specified protocol processing to the protocol processor which performs the specified protocol processing.

2. The classifier according to claim 1, wherein the processing circuitry notifies the additional information to the protocol processor by writing the additional information or an identifier of the additional information in any one of a descriptor, a processed region of the packet, an available region of a buffer storing therein the packet, and a register of the protocol processor.

3. The classifier according to claim 1, wherein, when a plurality of the protocol processes are specified to be performed on the packet, the processing circuitry notifies the additional information corresponding to the specified protocol processes to be performed by a plurality of the protocol processors, to the protocol processors, respectively.

4. The classifier according to claim 1, wherein, when a plurality of the protocol processes are specified to be performed on the packet, the processing circuitry notifies the additional information for each protocol processor to each protocol processor.

5. The classifier according to claim 1, wherein when a plurality of the protocol processes are specified to be performed on the packet, the processing circuitry notifies pieces of the additional information for the respective protocol processors collectively to each protocol processor.

6. The classifier according to claim 1, wherein, when a plurality of the protocol processes are specified to be performed on the packet, notification of the additional information to the protocol processor and the protocol processing by the protocol processor are repeatedly performed.

7. The classifier according to claim 1, wherein the classification information is at least one of: information included in a header of the packet; and a hush value calculated from the information included in the header.

8. The classifier according to claim 1, wherein the additional information is at least one of TCP management information, information included in TCB, and information included in PCB.

9. A communication device comprising:
the classifier according to claim 1;
at least one of the protocol processor; and
a hardware storage to store entries each having the classification information and the additional information associated with each other, wherein
the classifier searches for an entry corresponding to the packet from among the entries stored in the storage on the basis of the classification information of the packet, and when the entry corresponding to the packet is found out, the classifier notifies the additional information included in the found entry to the protocol processor.

10. The communication device according to claim 9, wherein the protocol processor performs the protocol processing on the packet which is notified from the classifier, by using the additional information notified from the classifier.

11. The communication device according to claim 9, further comprising a processor to process the packet, wherein
when the classifier fails to find out the entry corresponding to the packet, the classifier notifies the packet to the processor, and
the processor processes the notified packet.

12. The communication device according to claim 9, the processor creates the entry on the basis of the additional information and the classification information of the packet obtained during processing of the packet.

13. The communication device according to claim 9, wherein
the communication device comprises a plurality of the protocol processors, and
the entry includes an identifier that specifies the protocol processor associated with the additional information.

14. The communication device according to claim 9, wherein
the communication device comprises a plurality of the protocol processors, and
the entry is stored in a table provided for each protocol processor.

15. The communication device according to claim 9, further comprising a general protocol processor being callable of performing a plurality of the protocol processes.

16. The communication device according to claim 15, wherein the entry includes an identifier that specifies the protocol processing that is associated with the additional information, and that is performed by the general protocol processor.

17. The communication device according to claim 15, wherein the classifier notifies the packet to the processor and causes the processor to process the packet until changing of the protocol processing performed by the general protocol processor is completed.

18. The communication device according to claim 15, wherein, when a predetermined number or more of the packets that have the identical classification information are received, the classifier notifies the packets to the general protocol processor.

19. A communication method performed in a communication device including at least one protocol processor that performs a predetermined processing on a received packet, comprising:
specifying the protocol processing to be performed on the packet on the basis of classification information of the packet;
notifying the packet and additional information used for performing the specified protocol processing to the protocol processor which performs the specified protocol processing; and
performing by the protocol processor the protocol processing on the packet.
